(19) United States
(12) Patent Application Publication
(10) Pub. No.: US 2014/0047901 A1
(43) Pub. Date: Feb. 20, 2014

(54) SYSTEM FOR ON-LINE MEASURING AND CONTROLLING OF O2 FRACTION, CO FRACTION AND CO2 FRACTION

(71) Applicant: Aspect Imaging Ltd., Shoham (IL)

(72) Inventor: Uri RAPOPORT, Moshav Ben Shemen (IL)

(21) Appl. No.: 13/939,649

(22) Filed: Jul. 11, 2013

Related U.S. Application Data
(60) Provisional application No. 61/684,765, filed on Aug. 19, 2012.

(51) Int. Cl. G01N 21/17

(52) U.S. Cl. CPC G01N 21/1702
USPC 73/24.02

(57) ABSTRACT

A non-destructive resonance (NDR) method of measuring and controlling an O₂ fraction, a CO fraction, or a CO₂ fraction in a gas process stream. The method includes: determining the resonance frequency of an off-line standard gas composition; scanning a predetermined characteristic parameter around the predetermined resonance frequency; plotting a first 3D chart to obtain a 3D vector; flowing gas through the NDR system; on-line scanning a corresponding on-line measured parameter around the resonance frequency, and recording the same; plotting a second 3D chart to obtain a 3D vector which precisely identifies the value of the second measured parameter; comparing a 3D standard first vector to the 3D measured second vector; and correlating between a relative characteristic parameter change and the change in the gas fraction.

### FIELD OF THE INVENTION

The present invention generally pertains to a system and method for on-line measuring and controlling of O₂ fraction, CO fraction or CO₂ fraction.

### BACKGROUND OF THE INVENTION

Patent US2010/0164513 discloses a non-destructive on-line method and system for measuring predetermined physical, electrochemical, chemical and/or biological state transformation of a substance whereby said predetermined physical, electrochemical, chemical and/or biological state functions may be monitored and/or controlled.

Patent US2010/0164513 does not constitute prior art since it does not teach the use of the invention for measuring O₂, CO or CO₂.

U.S. Pat. No. 4,850,371A discloses a non-invasive method of measuring the cardiac output and cardio-respiratory function of a human subject which includes a gas sampling device which is inserted into the mouth. This patent teaches using a miniature motor pump to pass the gas to be sampled to an attached mass spectrometer device. This does not constitute prior art since, in the present invention, no pump is needed, as there does not need to be contact between the NDRS and the gas to be analyzed.

U.S. Pat. No. 6,174,289B teaches a method and apparatus particularly suited for use during a cardiopulmonary exercise test by a test subject. This patent teaches the use of separate O₂, CO and CO₂ sensors and also teaches the use of a pump to remove the sampled gas from the test station. Similarly, U.S. Pat. No. 6,921,369B also teaches use of separate O₂ and CO₂ sensors and a suction line for separating the gas to be analyzed from the rest of the exhaled breath.

There are many O₂, CO and CO₂ sensors available wherein the gas to be analyzed must impinge upon the sensor, either by having the sensor in the gas stream (JP61041959, EP0140295, U.S. Pat. No. 4,856,531, U.S. Pat. No. 4,909,072, U.S. 4,961,348, CH674677, U.S. Pat. No. 5,302,275, JP4296647, JP4320955, JP4320956, U.S. Pat. No. 5,435,169, WO9621 127, U.S. Pat. No. 6,214,208, U.S. Pat. No. 5,772,863, US2001025786, DE20200373U, US2005097941A, DE102004042919A, US2006229526A, CN1866027A, DE102005025285A, EP1764035A, US2007125665A, RU2323437C, US2009020120A, WO09030547A, US2011066061A, US2011045600A, WO09146693A, WO10005738A, WO10063624A, WO10063626A, WO10115434A), in contact or substantially in contact with a volume of gas to be analyzed (US2008012577A, US2010021993A), or by admitting a sample of the gas into a sensor chamber or sensor module (JP61041959, EP0140295, U.S. Pat. No. 4,856,531, U.S. Pat. No. 4,909,072, U.S. Pat. No. 4,961,348, CH674677, U.S. Pat. No. 5,302,275, JP4296647, JP4320955, JP4320956, U.S. Pat. No. 5,435,169, WO9621 127, U.S. Pat. No. 5,964,712, US2002017300A, US2005016871A, US2008022752A, US2006257094A, US2008110562A).

Other sensors require a clear line of sight through the gas to the sensor or between parts of the sensor mechanism (U.S. Pat. No. 5,708,957, US2001031224, US2002095096, US2003150334A, US2005239197A, WO03069316A, US2004097822A, US2007077167A, CN200972475Y, US2008041172A, US2010171043A, US2009056409A, US2009227887A). US2003150334A also requires periodic warming of at least some of the gas within the working environment, so that it does not teach a non-invasive method of measuring gas concentrations.

Some systems include both sensors that are immersed in the gas stream, and ones that require a clear line of sight between the gas being analyzed and the parts of the sensor (JP6043125, U.S. Pat. No. 6,192,738, WO11003720A).

U.S. Pat. No. 5,080,865 teaches a method by which the sampled gas is retained permanently in the sampling chamber.

It is therefore a long felt need to provide a sensor for O₂, CO and CO₂ wherein the sensor is not in contact with a possibly aggressive environment, which does not require line-of-sight through the gas to be analyzed to the sensor and which does not interfere with the flow of gas within the system being analyzed.

### SUMMARY OF THE INVENTION

It is an object of the present invention to disclose a system for system and method for on-line and in-line measuring and controlling of O₂ fraction, CO fraction or CO₂ fraction, or any combination thereof.

It is thus another object of the present invention to provide a non-contact, non-invasive on-line and in-line method for measuring and controlling of O₂ fraction, CO fraction or CO₂ fraction, or any combination thereof; comprised of (a) determining the resonance frequency, off line, of a standard substance to be measured; (b) scanning an off-line predetermined characteristic parameter around said predetermined resonance frequency, and recording the same, such that a standard comparative table is provided; plotting a first 3D chart to obtain a 3D vector which precisely identifies the value of said characteristic parameter; (c) on-line scanning a corresponding on-line measured parameter around the resonance frequency, and recording the same; (d) plotting a second 3D chart to obtain a 3D vector which precisely identifies the value of said second measured parameter; (e) comparing said 3D standard first vector to said 3D measured second vector; (f) obtaining relative characteristic parameter change; and (g) correlating between said relative characteristic parameter change and said O₂ fraction, CO fraction or CO₂ fraction, or any combination thereof.

It is within the scope of the present invention wherein the method is adapted for measuring the Smith chart of a substance comprising: (i) determining the resonance frequency of an off-line standard substance to be measured; (ii) scanning said Smith chart around said predetermined resonance frequency, and recording the same, such that a standard comparative table is provided; (iii) plotting a first Smith chart to obtain a 3D vector which identifies the value of said standard Smith chart; (iv) on-line scanning said corresponding on-line measured smith chart around said resonance frequency and recording the same; (v) plotting a second smith chart to obtain a 3D vector which identifies the value of said measured smith chart; (vi) comparing said first smith standard vector to said second smith measured vector; (vii) processing said smith vector to obtain an impedance curve as a function of said scanned frequency; (viii) obtaining the relative change of the impedance curve; and, (ix) correlating between said relative impedance curve and said O₂ fraction, CO fraction or CO₂ fraction, or any combination thereof.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1 schematically illustrates the system measuring gas input to and output from a catalytic converter system for an internal combustion system such as that in an automobile; and

FIG. 2 schematically illustrates a person using apparatus to measure the O₂, CO and CO₂ in the breath.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for on-line measuring and controlling of O₂ fraction, CO fraction or CO₂ fraction, or any combination thereof.

The term ‘on-line’ hereinafter refers to the operational measuring of the system available for immediate use avoiding human intervention.

The term ‘in-line’ hereinafter refers to the monitoring bring an integral part of a successive sequence of operations or machines during manufacturing process.

The term ‘plurality’ hereinafter refers to any integer greater than one.

The term ‘Smith Chart’ refers in the present invention to a type of chart used to plot variances of complex transmission impedance along its length. Smith chart denotes to a representation of a sequence of normalized impedance, admittance or reflection coefficient in a circle of unity radius. The Smith chart is plotted in two dimensions and is scaled in normalized impedance (the most common), normalized admittance or both, using different colors to distinguish between them. These are often known as the Z, Y and YZ Smith Charts respectively. Normalized scaling allows the Smith Chart to be used for problems involving any characteristic impedance or system impedance The Smith chart contains almost all possible impedances, real or imaginary, within one circle. With relatively simple graphical construction it is straightforward to convert between normalized impedance (or normalized admittance) and the corresponding complex voltage reflection coefficient.

The purpose of the Smith chart is to identify all possible impedances on the domain of existence of the reflection coefficient. The normalized impedance is represented on the Smith chart by using families of curves that identify the normalized resistance R (real part) and the normalized reactance X (imaginary part).

The term “impedance (Z)” refers hereinafter to a term that describes a measure of opposition to a sinusoidal alternating current. Electrical impedance extends the concept of resistance to AC circuits, describing not only the relative magnitudes of the voltage and current, but also the relative phases. Impedance refers to the steady state AC term for the combined effect of both resistance (R) and reactance (X), where Z=R+jX. (X=jwL for an inductor, and X=1/jwC for a capacitor, where w is the radian frequency or 2*π*f.) Generally, Z is a complex quantity having a real part (resistance) and an imaginary part (reactance).

The term “admittance (Y)” refers hereinafter to the inverse of the impedance (Z). The term “admittance” combines the effect of both conductance (G) and susceptance (B).

The term “susceptance (B)” refers hereinafter to the imaginary part of the admittance.

The current invention presents a method of non-invasively determining the O₂ fraction, CO fraction, CO₂ fraction and any combination thereof, especially adapted to be performed in-line and on-line and hence avoiding either affecting the gas fractions or interfering with the air stream.

In an embodiment, a standardized gas stream within a tube passes through a non-destructive resonance system (NDRS), preferably an MRI device. The measuring probe of the MRI, equipped with an analyzer, is calibrated and adjusted to a resonance frequency for a given gas composition. A Smith chart is measured and the measurement at the resonant frequency is recorded.

The analyzer is a network analyser or any other means of analyzing variations in the on-line measured parameter, such as the impedance of the probe, or the variation in the load on the coil.

The gas stream of interest then passes through the NDRS and the process repeated for the gas stream of interest. The analyzer determines the difference between the value of the Smith chart as measured by the measuring device and the value as stored in the standard database. The difference between the two values is correlated to the difference in gas fraction between the standard and the measured gas compositions.

In another embodiment, the resonance frequencies and the on-line resonance parameters are measured for a plurality of standardized concentrations for each gas, for at least one of the gases O₂, CO and CO₂. A Smith chart is measured and the measurement at the resonant frequency is recorded for ach standardized concentration.

The gas stream of interest then passes through the NDRS and the process is repeated for the gas stream of interest. The analyzer determines the concentration of the gas of interest from the difference between the value of the Smith chart as measured by the measuring device and the values as stored in the standard database. The difference between the values is correlated to the difference in gas fraction between the standard and the measured gas compositions.

### EXAMPLE 1

It is well known in the industry for internal combustion engines to have gas sensors to measure levels of gaseous constituents in the effluent gas stream from said engines, where the output from said sensors is used to monitor the performance of said engines and to control and optimize said performance. In the best embodiment of the present system, said sensors are NDRS sensors.

It is well known in the industry for internal combustion engines equipped with catalytic converters to have gas sensors upstream and/or downstream of said catalytic converters to monitor the performance of said catalytic converters. Said monitoring can be for the purpose of ensuring that said catalytic converter reaches its optimum operating conditions as rapidly as possible after said engine is started, or for maintaining said optimum operating conditions during use of said engine, or for restoring said converter to an optimum operating state, for example by altering the temperature of the converter so that chemicals degrading its performance are “burned off”, or to notify the user of said engine that the performance of said catalytic converter has become degraded, so that said user can cause said catalytic converter to be cleaned, repaired or replaced. In another embodiment of the present system, said sensors are NDRS sensors.

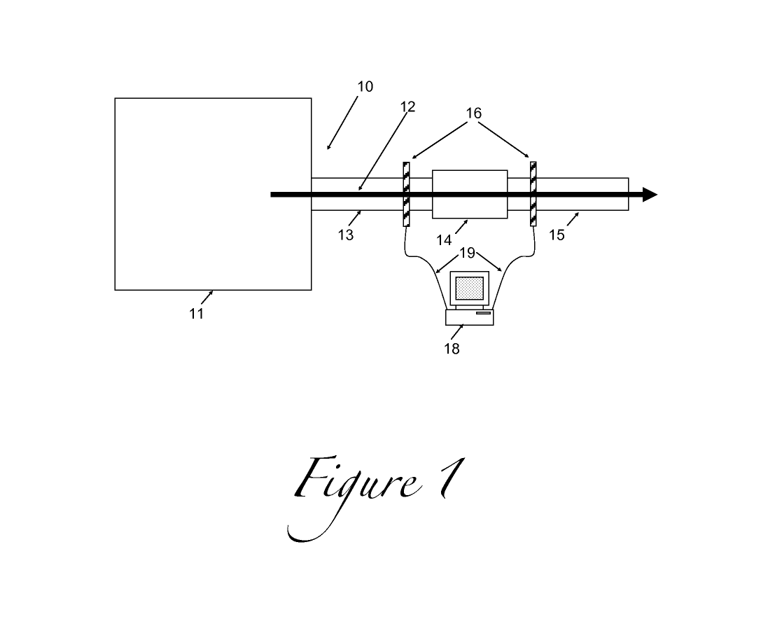

FIG. 1 is a schematic diagram of this embodiment. In FIG. 1, an internal combustion system (10), such as that in an automobile, has an engine (11) that produces exhaust gases (12) which pass through an exhaust system. Said exhaust system consists of a tube (13) connecting the engine and a catalytic converter (14), and a second tube (15) to the outside of the system. The NDRS sensors (16) are disposed around the outsides of the tubes (13, 15). The muffler commonly used with such systems is not shown. The NDRS sensors (16) are connected to a microprocessor or microprocessors or a computer system (18) to monitor the O₂ fraction, CO fraction, CO₂ fraction or any combination thereof in the exhaust gases from the engine and in the gases downstream of the catalytic converter. In this embodiment, the NDRS sensors (16) are connected to the microprocessor or microprocessors or computer system (18) via wires (19). Said microprocessor or microprocessors or computer system (18) monitors the fraction, CO fraction, CO₂ fraction or any combination thereof at the locations of the NDRS sensors. Said fractions are then passed to one or more control systems to control engine function and to ensure optimum performance of the engine and the catalytic converter,

In another embodiment, the NDRS sensors (16) are connected to the microprocessor or microprocessors or computer system (18) wirelessly via a transceiver or transceivers.

In another embodiment of the present system, the NDRS performs on-line and in-line measurement of O₂ fraction, CO fraction, CO₂ fraction or any combination thereof in a fluid process stream.

In another embodiment of the present system, the NDRS performs on-line and in-line measurement of O₂ fraction, CO fraction, CO₂ fraction or any combination thereof in a fluid process stream on a production line.

In another embodiment of the present system, the NDRS performs on-line and in-line measurement of O₂ fraction, CO fraction, CO₂ fraction or any combination thereof in the fluid process stream of a batch process.

In another embodiment of the present system, the NDRS performs on-line and in-line measurement of O₂ fraction, CO fraction, CO₂ fraction or any combination thereof in the fluid or solid of a batch process.

### EXAMPLE 2

It is well known in the industry that plant products such as fruits and vegetables absorb gases such as O₂ and CO₂ from the atmosphere surrounding them as they ripen and also emit gases such ethylene. It is well known in the industry that monitoring changes in the atmosphere can be used to determine the degree of ripeness of fruits and vegetables, and that control of the atmosphere surrounding said plant products can be used to control ripening. In another embodiment of this system, the NDRS sensors monitor the O₂ and CO₂ in the atmosphere of fruit or vegetable storage areas, whether chambers or containers, to monitor the ripeness of the fruit or vegetables therein, to adjust said atmosphere in order to control the speed of ripening, to determine whether the fruits or vegetables therein are sufficiently ripe to be salable, or any combination of these.

In another embodiment of the present system, the NDRS monitors the concentrations of O₂ and CO₂ in the atmosphere surrounding individual fruits or vegetables. Abnormal absorption of O₂ or emission of CO₂ would signal a fruit or vegetable ripening abnormally quickly, such as a wormy, bruised, or fungus-infected one. Said fruit or vegetable could then be recognized early, before color changes or unusual softness would signal the abnormal ripening, and removed, either manually or automatically.

In another embodiment of the present system, if a stagnant atmosphere is provided on a fruit or vegetable packing line, and NDRS on said packing line could be used to identify and remove fruits or vegetables that were ripening abnormally rapidly, thus ensuring that such fruits or vegetables do not reach the consumer and that they do not cause rapid ripening of other fruits or vegetables in their vicinity, thereby ensuring that fruits and vegetables reach the consumer in good condition.

In yet another embodiment of the present system, the NDRS can be used to monitor O₂, CO₂ and optionally CO in the expired breath of an animal, or to control the O₂, CO₂ and optionally CO in the inspired breath of an animal or to do both. Such breathing monitors are commonly used to determine lung function, diagnose certain types of lung obstruction, and as monitors during exercise. They are also used to ensure the correct delivery of O₂, CO₂ and drugs to patients with compromised breathing or during operations, or to deliver controlled amounts of O₂ and CO₂ to athletes during training, such as for simulated high-altitude training.

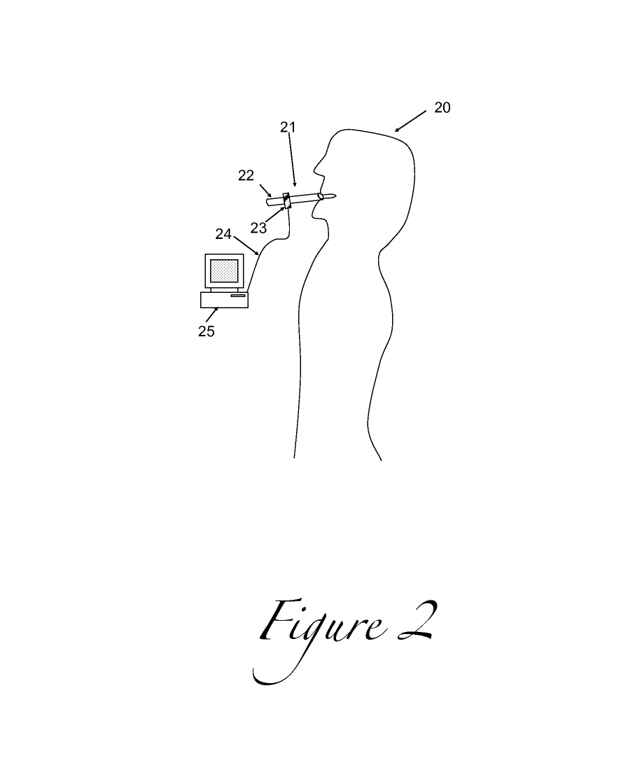

In the embodiment schematically shown in FIG. 2, the O₂, CO and CO₂ in the breath of a person (20) are monitored using the device (21). The device consists of a tube or tubes (22) with attached NDRS (23). The person breathes through the tube or tubes, and the O₂, CO and CO₂ in the breath are monitored using the NDRS (23). The NDRS signals are transmitted via the wire (24) to the microprocessor or microprocessor or computer system (25) for processing.

In another embodiment, that NDRS signals are transmitted to the microprocessor or microprocessor or computer system (25) wirelessly via a transceiver or transceivers.

In another embodiment, the patient breathes through a face mask and the NDRS is attached to the face mask.

In another embodiment, the patient breathes through a face mask and the NDRS is attached to tubes supplying gas to the face mask.

In another embodiment, the O₂, CO or CO₂ fractions or any combination of these in the expired breath are used to control the fractions of O₂, CO, CO₂, other gases or drugs or any combination thereof to be supplied to the person or other animal using the device.

In another embodiment, the gas fractions to be supplied to the person or other animal are monitored by the NDRS or by another NDRS. Said gases may be supplied via the same tube through which the person or animal exhales or via another tube or tubes or via a face mask.

1. A non-destructive resonance (NDR) method for on-line, in-line or any combination thereof measuring and controlling of O₂ fraction, CO fraction, CO₂ fraction and any combination thereof in a gas process stream, comprising steps of
a. providing an NDR system;
b. determining the resonance frequency of an off-line standard gas composition to be measured;
c. scanning an off-line predetermined characteristic parameter around said predetermined resonance frequency and recording the same, such that a standard comparative table is provided;
d. plotting a first 3D chart to obtain a 3D vector which precisely identifies the value of said characteristic parameter;
e. flowing gas through the NDR system;
f. on-line scanning a corresponding on-line measured parameter around the resonance frequency, and recording the same;
g. plotting a second 3D chart to obtain a 3D vector which precisely identifies the value of said second measured parameter;
h. comparing said 3D standard first vector to said 3D measured second vector;
i. obtaining a relative characteristic parameter change; and
j. correlating between said relative characteristic parameter change and said change in gas fraction.

2. The method according to claim 1, adapted for measuring Smith chart of a gas process stream comprising:
a. determining the resonance frequency of an off-line standard substance to be measured;
b. scanning said Smith chart around said predetermined resonance frequency, and recording the same, such that a standard comparative table is provided;
c. plotting a first Smith chart to obtain a 3D vector which identifies the value of said standard Smith chart;
d. on-line scanning said corresponding on-line measured smith chart around said resonance frequency and recording the same;
e. plotting a second Smith chart to obtain a 3D vector which identifies the value of said measured smith chart;
f. comparing said first Smith standard vector to said second Smith measured vector;
g. processing said Smith vector to obtain an impedance curve as a function of said scanned frequency;
h. obtaining the relative change of the impedance curve; and
i. correlating between said relative impedance curve and said PPECB state transformation

3. The NDR method of claim 1, wherein the fluid process stream is on a production line.

4. The NDR method of claim 1, wherein the on-line measuring and controlling of O₂ fraction, CO fraction, CO₂ fraction or any combination thereof is for a batch process.

5. The NDR method of claim 1, wherein the on-line and in-line measuring and controlling of O₂ fraction, CO fraction, CO₂ fraction or any combination thereof is for an engine or combustion chamber.

6. The NDR method of claim 1, wherein the on-line measuring and controlling of O₂ fraction, CO fraction, CO₂ fraction or any combination thereof is for the effluent from said engine or combustion chamber.

7. The NDR method of claim 6, especially adapted to function as a sensor upstream of catalytic converters, downstream of said converters and any combination thereof.

8. The NDR method of claim 3, wherein the fraction of O₂, CO, CO₂ or any combination thereof is optimized.

9. The NDR method of claim 6, wherein the concentration of CO is minimized.

10. The NDR method of claim 3, wherein the completeness of the reaction O₂+CO->CO₂ is maximized.

11. The NDR method of claim I, wherein the on-line measuring of O₂ fraction, CO fraction, CO₂ fraction or any combination thereof determines the degree of ripeness of plant products from changes in O₂, CO, CO₂ and any combination thereof in the atmosphere surrounding said plant products.

12. The NDR method of Claim 11, wherein the degree of ripeness of plant products is controlled.

13. The NDR method of claim 1, wherein the concentration of O₂, CO, CO₂ and any combination thereof in the breath of an animal is monitored.

14. The NDR method of claim 4, wherein the fraction of O₂, CO, CO₂ or any combination thereof is optimized.

15. The NDR method of claim 5, wherein the fraction of O₂, CO, CO₂ or any combination thereof is optimized.

16. The NDR method of claim 6, wherein the fraction of O₂, CO, CO₂ or any combination thereof is optimized.

17. The NDR method of claim 7, wherein the fraction of O₂, CO, CO₂ or any combination thereof is optimized.

18. The NDR method of claim 4, wherein the completeness of the reaction O₂+CO->CO₂ is maximized.

19. The NDR method of claim 5, wherein the completeness of the reaction O₂+CO->CO₂ is maximized.

20. The NDR method of claim 6, wherein the completeness of the reaction O₂+CO->CO₂ is maximized.

21. The NDR method of claim 7, wherein the completeness of the reaction O₂+CO->CO₂ is maximized.
